(19) United States
(12) Patent Application Publication
(10) Pub. No.: US 2009/0198418 A1
(43) Pub. Date: Aug. 6, 2009

(54) Side impact detection apparatus

(75) Inventor: Yasuo Itoga, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 12/314,374

(22) Filed: Dec. 9, 2008

(30) Foreign Application Priority Data
Feb. 1, 2008 (JP) 2008-023192

(51) Int. Cl. G06F 7/00; G01B 7/00

(52) U.S. Cl. 701/46; 324/207.15; 701/48

(57) ABSTRACT

An apparatus for detecting information related to a side impact of a vehicle includes a sensor spaced from a metal object and located in a space defined by vehicle door panels, and a mounting portion to which the sensor is attached relative to the vehicle door. The sensor includes a ring-like coil parallel to the object, a housing for the coil that is coaxial with the coil, and a sensor bracket between the coil housing and the mounting portion. The sensor bracket includes a ring-like peripheral portion joined along a ring-like portion of the coil housing, a bottom portion spaced apart from and extending on the opposite side of the object with regard to the coil housing, and a standing portion between the peripheral portion and the bottom portion. The sensor detects a distance between the coil and the object based on a variation in current flowing through the coil.

### BACKGROUND

The present disclosure relates generally to the field of side impact detection in a vehicle.

Various conventional vehicle impact sensors are used to detect a collision in the event of a vehicle accident. What is needed is an advanced detecting technology that is capable of better detecting a vehicle collision to improve occupant restraint.

### SUMMARY

One embodiment of the disclosure relates to a side impact detection apparatus for detecting information related to a side impact of a vehicle. The apparatus includes a detection sensor disposed in a space defined by an outer door panel and an inner door panel of a vehicle door. The detection sensor is spaced from a detection object made of a metal. The apparatus also includes a mounting portion to which the detection sensor is attached relative to the vehicle door. The detection sensor includes a ring-like coil extending parallel to the detection object and a coil housing to accommodate the coil. The coil housing is coaxial with the coil. The detection sensor also includes a sensor bracket disposed between the coil housing and the mounting portion. The sensor bracket is a bottom member that includes a ring-like peripheral portion joined along a ring-like portion of the coil housing and a bottom portion extending on the opposite side of a detection object with regard to the coil housing. The bottom portion is spaced apart from the detection object. The sensor bracket also includes a standing portion between the peripheral portion and the bottom portion. The detection sensor detects a distance between the coil and the detection object based on a variation in current flowing through the coil.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a schematic illustration showing an occupant restraint system installed in a vehicle in which a vehicle occupant is sitting according to an exemplary embodiment.

FIG. 2 is an illustration showing the basic structure of a detection sensor in an occupant restraint system according to an exemplary embodiment.

FIG. 3 is a schematic illustration showing the sectional structure of a vehicle door in which a detection sensor is installed according to an exemplary embodiment.

FIG. 4 is a schematic illustration showing a section of the structure of a vehicle door in an occupant restraint system when the vehicle door collides with a pole from the side according to an exemplary embodiment.

FIG. 5 is a perspective view of a detection sensor according to an exemplary embodiment.

FIG. 6 is a perspective view of a coil housing as a component of a detection sensor according to an exemplary embodiment.

FIG. 7 is a perspective view showing a mounted detection sensor according to an exemplary embodiment.

FIG. 8 is a perspective view showing a beam bracket to which a detection sensor may be attached according to an exemplary embodiment.

FIG. 9 is a schematic illustration showing a partial cross section structure and planar structure of a detection sensor according to an exemplary embodiment.

FIGS. 10-12 are schematic illustrations showing positioning mechanisms according to various exemplary embodiments.

FIGS. 13-17 are schematic illustrations showing a fixing structure according to various exemplary embodiments.

FIGS. 18-21 are schematic illustrations showing a harness holding mechanisms according to various exemplary embodiments.

FIG. 22 is an illustration of an obstacle avoiding structure in which a detection sensor is attached to a vehicle door beam as viewed from an exterior of the vehicle according to an exemplary embodiment.

FIG. 23 is a partial sectional view of the first obstacle avoiding structure of FIG. 22 according to an exemplary embodiment.

FIG. 24 is an illustration of an alternative obstacle avoiding structure in which a detection sensor is attached to a vehicle door beam as viewed from an interior of the vehicle according to an exemplary embodiment.

FIG. 25 is an illustration of another alternative obstacle avoiding structure in which a detection sensor is attached to a vehicle door beam as viewed from an interior of the vehicle according to an exemplary embodiment.

### DETAILED DESCRIPTION

According to one exemplary embodiment a system for detecting a side impact of a vehicle uses of a G sensor or a contact sensor that is actuated in the event of a vehicle side impact crash, as disclosed in JP-A-07-172262, which is herein incorporated by reference in its entirety. The system may be configured for restraining a vehicle occupant using an occupant restraint system such as an airbag module in the event of a vehicle accident.

According to various exemplary embodiments, a technology is used that may be effective for properly detecting the impact mode in the event of a vehicle side impact crash. Though the present application is directed to a technology for detecting information about a side impact occurred on an automobile, the technology disclosed herein may be also adapted to a technology for detecting information about a side impact occurred on a vehicle other than the automobile. According to various exemplary embodiments, the vehicle may be any of various vehicles such as an automobile, airplane, a boat, a train, a bus, and a truck,

A side impact detection apparatus according to the present disclosure is a system for detecting information about a side impact on a vehicle and includes at least a detection sensor and a mounting portion. The detection sensor is a sensor that is disposed in a space defined by an outer door panel and an inner door panel of a vehicle door, and is spaced from a detection object made of a metal. According to various exemplary embodiments, the detection sensor may be a single detection sensor or a combination of a plurality of detection sensors. The mounting portion is a portion to which the detection sensor is attached relative to the vehicle door. The mounting portion may be various members exposed to the space defined by the outer door panel and the inner door panel of the vehicle door. The detection sensor may be attached to a door beam, an extending member similar to the door beam, or the inner door panel itself.

The detection sensor includes a ring-like coil that extends parallel to the detection object, a coil housing that accommodates the coil and is coaxial with the coil, and a sensor bracket that is disposed between the coil housing and the mounting portion. The detection sensor is adapted to detect a distance between the coil and the detection object based on variation in current flowing through the coil when energized. The metallic detection object may have a confronting surface as a conductive member or a magnetic member containing, for example, steel, copper, aluminum, and/or ferrite. According to various exemplary embodiments, the coil that extends parallel to the detection object may be any arrangement in which the extending surface of the detection object and the extending flat face of the coil are disposed parallel to each other. The coil may also be any arrangement in which the extending surface of the detection object and the extending flat face of the coil are inclined to have a predetermined inclination angle relative to each other. Preferably, the detection sensor may be disposed such that the surface to be detected of the detection object and the extending flat face of the coil are substantially parallel to each other. The detection sensor or coil sensor uses a coil to detect a metallic detection object and is a noncontact sensor. Therefore the detection or coil sensor may be resistant to shock, may not be sensitive to the shock, and/or may be barely affected by environment. Therefore, the coil sensor may be effective in ensuring a desired accuracy.

The sensor bracket is a bottom member that includes a ring-like peripheral portion joined along a ring-like portion of the coil housing, a bottom portion that extends on the opposite side of a detection object with regard to the coil housing and that is spaced apart from the detection object, and a standing portion standing between the peripheral portion and the bottom portion. The sensor bracket may be any bracket attached to the bottom member and that includes at least a peripheral portion, a bottom portion, and a standing portion.

According to an exemplary embodiment, the coil sensor may have a high detection accuracy relative to the metallic detection object. The ring-like portion of the coil housing may be evenly supported by the peripheral portion of the sensor bracket to maintain the rigidity and strength of the coil housing, thereby maintaining the original high detection accuracy of the coil sensor. By maintaining the rigidity and the strength of the ring-like coil housing via the sensor bracket, the mode of a side impact on the vehicle may be properly detected.

According to another exemplary embodiment, it may be preferable that the sensor bracket includes a reinforcing rib for reinforcing the sensor bracket. The rib projects from the extending surface of the bottom portion in a direction perpendicular to the extending surface of the coil housing. The reinforcing rib includes one or more coaxial circular portions That are formed coaxially with the peripheral portion. According to various exemplary embodiments, the coaxial circular portions may be any shape with a circle being coaxial with the ring-like periphery and may include not only a circle that is continuous in a circumferential direction but also a circle that is intermittent in the circumferential direction. Because the reinforcing rib has one or more coaxial circular portions that are formed coaxially with the peripheral portion, the sensor bracket may be strengthened and reinforced, thereby maintaining high rigidity and strength of the coil housing.

According to another exemplary embodiment, the reinforcing rib may have a predetermined thickness and the coaxial circular portions may form at least one ridge and valley (a wave) from a sectional view along a direction perpendicular to the extending surface of the coil housing. Because the reinforcing rib has one or more coaxial circular portions that are coaxial with the peripheral portion of the sensor bracket, the sensor bracket may be effectively reinforced and the reinforcing rib may be formed with a constant or uniform thickness.

According to another exemplary embodiment, at least one of the coil housing and the sensor bracket may include a harness holding mechanism for holding a harness extending from the coil. The harness may be securely held o fastened by the beam bracket or the sensor bracket to prevent the harness from loosening without using a separate harness holding member. By securely holding or fastening the harness to the beam bracket or the sensor bracket to properly position the harness, the mode of a side impact on a vehicle may be properly detected.

According to another exemplary embodiment, the detection sensor may be located at a position to prevent an obstacle from disturbing the detection of the detection object by the detection sensor. For example, the obstacle that may disturb the detection of the detection object may be a physical obstacle (e.g., a door window) that may physically interfere with the detection sensor according to the deformation of the vehicle door in the event of a vehicle collision, or an electrical obstacle (e.g., a speaker, a harness, an antenna (radio transceiver), a motor, a solenoid, etc.), which may electrically disturb detection of the detection object. To prevent the obstacle from disturbing the detection, an arrangement may be used in which the detection sensor is disposed at a position spaced from each physical obstacle that may physically interfere with the detection sensor and an arrangement in which the detection sensor is disposed at a position where the detection sensor is not electrically affected by any electrical obstacle or a position where electrical influence is below a predetermined reference value. Such an arrangement may prevent the detection sensor from interfering with any physical obstacle or prevent the detection sensor from being electrically affected by any electrical obstacle to ensure proper action and detection of the detection sensor. By preventing the detection sensor from being affected by any physical obstacle or any electrical obstacle, the mode of a side impact on the vehicle may be properly detected.

According to another exemplary embodiment, the side impact detection apparatus preferably further includes a determination unit for determining the mode of a side impact on the vehicle based on the information detected by the detection sensor. Typically, the determination unit determines whether the occurred side impact should result in immediate restraint of a vehicle occupant, whether the impact is a minor impact that is not likely to need or does not need to immediately restrain the vehicle occupant, or whether the side impact is a collision with an road or roadside structure or other object. The determined information about the mode of the side impact may be used to control occupant restraint apparatuses such as an airbag module and a seat belt device, which are actuated for restraining the vehicle occupant in the event of a vehicle side impact crash. The information may also be used to control a warning device for outputting a warning message such as a display and/or audible indication for informing the vehicle occupant of a vehicle side impact crash. The information may also be used to control another object. The mode of the side impact on the vehicle may be determined based on proper information detected by the detection sensor.

According to an exemplary embodiment, an occupant restraint system may generally include at least a side impact detection apparatus as mentioned above, an occupant restraint apparatus, and a control unit.

The occupant restraint apparatus is an apparatus for restraining a vehicle occupant in the event of a vehicle collision. According to various exemplary embodiments, the occupant restraint apparatus may include occupant restraint apparatuses such as an airbag device (airbag module) and a seat belt device. When an airbag device is used as the occupant restraint apparatus, the airbag may be installed or mounted in a seat, a pillar, or an upper roof rail of the vehicle.

The control unit may be configured to at least control the occupant restraint apparatus based on information determined by the determination unit of the side impact detection apparatus, i.e. based on the mode of impact in the event of a side impact crash of the vehicle. The control unit may be configured to output an actuation signal to the airbag device and/or the seat belt device when the determination unit determines that the occurred side impact should result in immediate restraint of the vehicle occupant. Additionally, the control unit may be configured to change the occupant restraining mode of the airbag device and/or the seat belt device by estimating the impact energy based on the displacement information of the setting area in the event of the side impact crash. The control unit may be configured to only control the occupant restraint apparatus or may be an existing device for controlling the actuation of an engine/running system and an electrical system as well as for controlling the occupant restraint apparatus. The occupant restraint apparatus may be controlled using information determined by the determination unit of the side impact detection apparatus to promote complete restraint of a vehicle occupant.

According to an exemplary embodiment, a vehicle may include at least an engine/running system, an electrical system, an actuation control device, a vehicle door, a sensor device, and an actuation signal output device. The engine/running system is a system involving an engine and a running mechanism of the vehicle. The electrical system is a system involving electrical parts used in the vehicle. The actuation control device is a device having a function of controlling the actuation of the engine/running system and the electrical system. The vehicle door is a door for allowing access of a vehicle occupant relative to the vehicle and is displaceable according to a vehicle side impact. The sensor device is a device for deriving information about displacement of the vehicle door. The sensor device includes the aforementioned side impact detection apparatus. The control signal output device is configured to output a control signal to an object to be controlled based on the information derived by the sensor device. According to various exemplary embodiments, the object to be controlled may include occupant restraint apparatuses such as an airbag module and a seat belt device that are actuated for restraining the vehicle occupant in the event of a vehicle side impact crash and objects to be controlled such as a warning device for outputting graphical/textual or audible warnings for informing the vehicle occupant of a vehicle side impact crash. The control signal output device may be configured to only control the object or may be an existing device for controlling the actuation of the engine/running system and the electrical system as well as for controlling the detection object. A vehicle may be provided in which proper information determined by the determination unit of the side impact detection apparatus is used for various controls with regard to the vehicle.

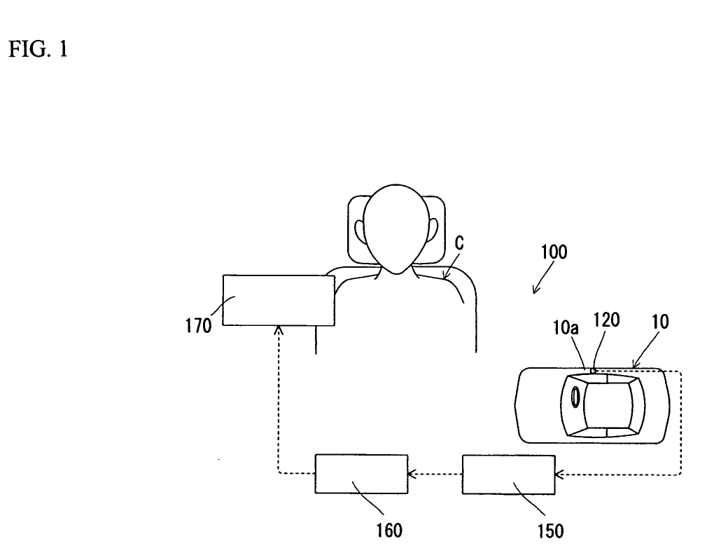

Hereinafter, description will be made with regard to an occupant restraint system 100 as an exemplary embodiment of the occupant restraint system of the present disclosure with reference to FIG. 1 through FIG. 4. According to various exemplary embodiments, the occupant restraint system may include an airbag module with an airbag that may be deployed and inflated into an occupant restraint region in the event of a vehicle accident. Though the airbag module used for a vehicle occupant (driver) in a vehicle seat on a right side in a vehicle cabin is described in an example shown in FIG. 1, the occupant restraint system of this embodiment may be adapted to an airbag module for an occupant in any vehicle seat such as a driver's seat, a front passenger seat, and a rear seat.

FIG. 1 is a schematic illustration showing a configuration of an occupant restraint system 100 installed in a vehicle 10 in which a vehicle occupant C is seating according to an exemplary embodiment. As described in detail below, the occupant restraint system 100 includes a detection sensor 120 installed in a vehicle door 10a that is opened and closed to allow a vehicle occupant C to get in or out the vehicle 10.

The vehicle 10 includes a number of vehicle components for example an engine/running system involving an engine and a running mechanism of the vehicle, an electrical system involving electrical parts used in the vehicle, and an actuation controller for conducting the actuation control of the engine/running system and the electrical system. Particularly, the occupant restraint system 100 is installed in the vehicle 10.

As shown in FIG. 1, the occupant restraint system 100 is configured to immediately or almost immediately restrain the vehicle occupant C in the event of a side impact crash of the vehicle 10 using information about the side impact. The occupant restraint system 100 includes at least the detection sensor 120, a deriving unit 150, a determination unit 160, and an airbag module 170. The detection sensor 120, the deriving unit 150, and the determination unit 160 compose a side impact detection apparatus for detecting information about the side impact on the vehicle 10.

As described in detail below, the detection sensor or sensor device 120 is a sensor or displacement sensor for detecting information about displacement of the vehicle door 10a in the event of a side impact crash of the vehicle 10. The displacement information detected by the detection sensor 120 is transmitted to the deriving unit 150. Alternatively, the detection sensor 120 may be another sensor installed to a vehicle body member such as a vehicle door, a rim, or a pillar configured to detect information about a vehicle side impact.

The deriving unit 150 is configured for deriving the displacement information of the vehicle door 10a, which may be displacing toward the inner side of the vehicle, based on the information transmitted from the detection sensor 120. The displacement information derived by the deriving unit 150 is transmitted to the determination unit 160. The deriving function of the deriving unit 150 may be one of the features of the detection sensor 120 or a separate feature from the detection sensor 120.

The determination unit 160 (or control unit or control signal output device) is configured for determining the mode of a side impact on the vehicle 10 based on the information transmitted from the deriving unit 150 and is configured for controlling the airbag module 170 based on the determination. Specifically, the determination unit 160 may include a CPU (central processing unit), an input/output unit, a storage unit, a driving unit, a peripheral unit, and the like. The determination unit 160 may be configured as all or a part of an electronic control unit (ECU) as an actuation control device for controlling the actuation of an engine/running system and an electrical system of the vehicle 10. The hardware or software for determining the mode of the side impact on the vehicle 10 and the hardware or software for outputting a control signal to the airbag module 170 may be configured as separate hardware or software modules.

The airbag module 170 is the occupant restraint apparatus and object to be controlled described above and generally includes at least an airbag and a gas generator (not shown). The airbag is configured to be deployed and inflated into an occupant restraint region with gas supplied from the gas generator when an accident of the vehicle 10 is detected. Therefore, the vehicle occupant C may be restrained by the controlled airbag module 170 in the event of a vehicle accident.

According to some exemplary embodiments, an occupant restraint apparatus other than the airbag module 170 may be employed in addition to the airbag module 170 or instead of the airbag module 170. The occupant restraint apparatus may be an occupant restraint apparatus such as a seat belt device or a warning device for outputting graphical/textual or audible warnings.

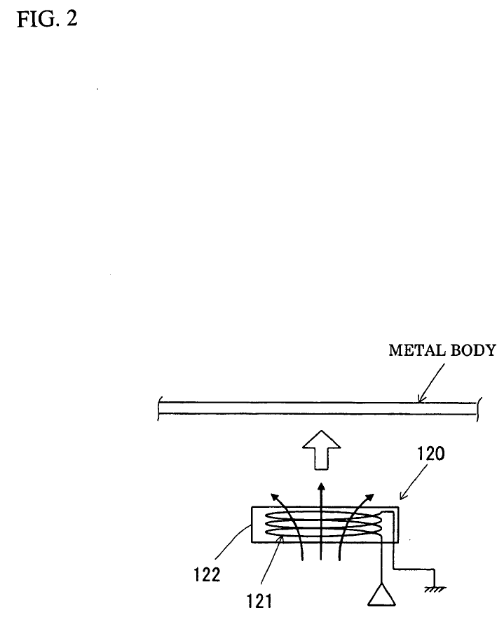

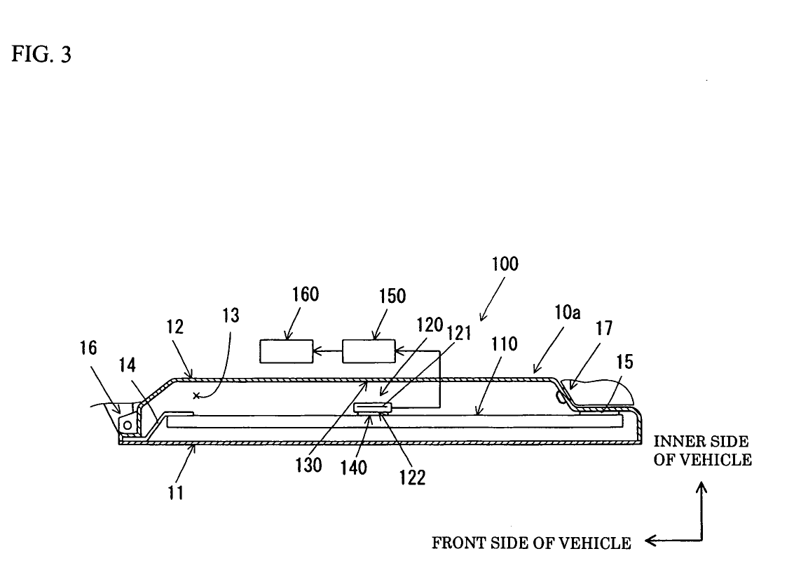

The arrangement of the detection sensor 120 and peripheral components are described with reference to FIG. 2 and FIG. 3. FIG. 2 shows the basic structure of the detection sensor 120 according to an exemplary embodiment and FIG. 3 schematically shows the sectional structure of the vehicle door 10a in which the detection sensor 120 is installed.

As shown in FIG. 2, the detection sensor 120 is a coil sensor including a coil housing 122 and includes a coil 121 that is formed by winding a wire once or several times into a full circle and is accommodated in the coil housing 122. The detection sensor 120 is preferably disposed such that the coil 121 extends parallel to a metallic detection object. Typically, the metallic detection object is a detection surface of a metal body that extends substantially parallel to the extending surface of the coil 121. The detection sensor 120 may be disposed such that the detection surface of the metal body and the extending surface of the coil 121 are inclined to have a predetermined inclination angle relative to each other. The actuation of an AC power source (not shown) energizes the coil 121 with alternative current (sinusoidal current) and applies an AC magnetic field to the metal body (conductive body or magnetic body) near the coil 121 to produce an eddy current on the metal body through electromagnetic induction. The eddy current produces a magnetic field and a part of this magnetic field intersects with the coil. As a result, the magnetic flux generated by the eddy current flowing through the metal body is added to the magnetic flux generated by the current supplied from the AC power source unit. These magnetic fluxes produce an induced voltage in the coil 121.

The detection sensor 120 may detect the distance between the metal body and the detection sensor 120 based on a variation in current flowing through the coil. The metal body may be a detection object near the coil sensor and may be formed of a conductive member or a magnetic member containing, for example, steel, aluminum, and/or ferrite. Because the aluminum has high conductivity and a large eddy current is produced by the coil sensor, the metal body is advantageously made of a metal containing aluminum to improve detection sensitivity. If the distance between the coil sensor and the metal body is, for example, about 40 mm in an initial state, use of a coil 121 of 80 mm or more in diameter may enable improvement of detection sensitivity. The coil sensor is a noncontact sensor and thus is resistant to shock, is not sensitive to shock, and/or is hardly affected by the environment. Therefore, the coil sensor may be effective in ensuring a desired detection accuracy.

As shown in FIG. 3, the vehicle door 10a is connected to a vehicle body 17 via door hinges 16 and includes an outer door panel 11 composing an outer wall part of the vehicle and an inner door panel 12 composing an inner wall part of the vehicle. The vehicle door 10a may be a front door that is disposed between an A-pillar and a B-pillar of the vehicle 10 or a rear door that is disposed between a B-pillar and a C-pillar of the vehicle 10. A door beam 110 made of metal is arranged in a space 13 defined by the outer door panel 11 and the inner door panel 12.

The door beam 110 is a cylindrical, rod-like, or column-like member extending lengthwise in the anteroposterior direction of the vehicle. One end of the door beam 110 is fixed to the vehicle body 17 via a vehicle front side bracket 14, while the other end of the door beam 110 is fixed to the vehicle body 17 via a vehicle rear side bracket 15. The door beam 110 is fixed at both ends corresponding to the brackets 14 and 15 to extend lengthwise between the front end of the door (the vehicle front side bracket 14) and the rear end of the door (the vehicle rear side bracket 15) in the anteroposterior direction of the vehicle.

The detection sensor 120 is placed in a predetermined setting area among portions of the door beam 110 to face a confronting surface 130 of the inner door panel 12. Though the setting area in which the detection sensor 120 is mounted on the door beam 110, the setting area may be set directly on the door beam 110 or set on another member fixed to the door beam 110. Alternatively, the detection sensor 120 may be attached to the inner door panel 12 side and a confronting surface similar to the confronting surface 130 may be mounted on the door beam 110 itself or another member fixed to the door beam 110.

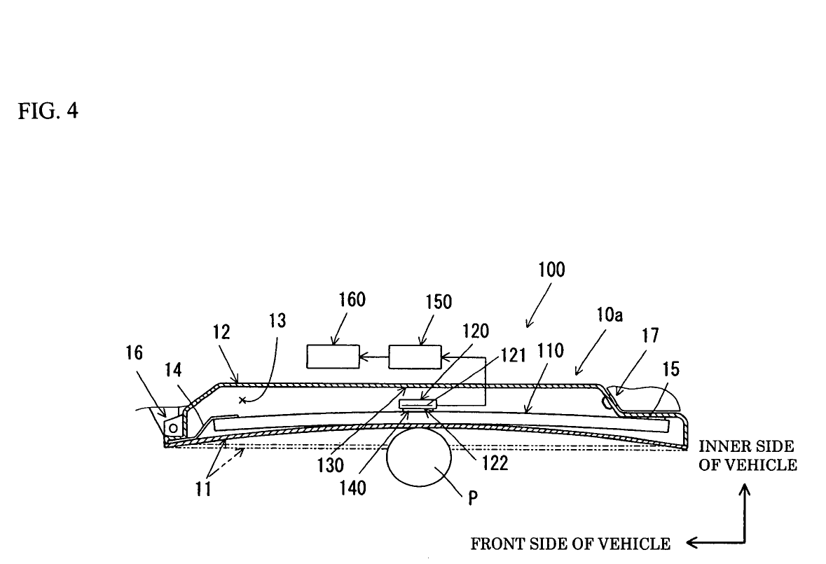

The action of the occupant restraint system 100 is described with reference to FIG. 4. FIG. 4 schematically illustrates a section of the structure of the vehicle door 10a in the occupant restraint system 100 when the vehicle door 10a collides with a pole P from the side, according to an exemplary embodiment.

In the example of FIG. 4, the vehicle 10 collides with the pole P, such as a utility pole, and the outer door panel 11 of the vehicle door 10a as shown in FIG. 4 is subjected to an impact from the side (from the lower side in FIG. 4) and is displaced (or deformed or moved) to the inside of the vehicle (to the upper side in FIG. 4). The outer door panel 11 is displaced from, for example, a position shown by two dot chain lines in FIG. 4 to a position shown by solid lines in FIG. 4 by a side impact crash with the pole P. According to this displacement, the door beam 110 pressed via the outer door panel 11 is deflected and moved toward the inside of the vehicle. During the deflection of the door beam 110, the detection sensor 120 moves toward the confronting surface 130 of the inner door panel 12 and is displaced to the inner side of the vehicle. Accordingly, the displacement of the detection sensor 120 relative to the confronting surface 130 of the inner door panel 12 is detected by the coil 121 and the detection sensor 120. Specifically, based on the variation in electric current flowing through the coil 121 of the detection sensor 120, the moving distance between the detection sensor 120 and the confronting surface 130 (the amount of displacement) is successively detected by the deriving unit 150. With this detection, the determination unit 160 determines the mode of the side impact of the vehicle 10. According to the determination, the airbag module 170 is actuated, whereby the vehicle occupant C is restrained by the airbag that is deployed and inflated into the occupant restraint region.

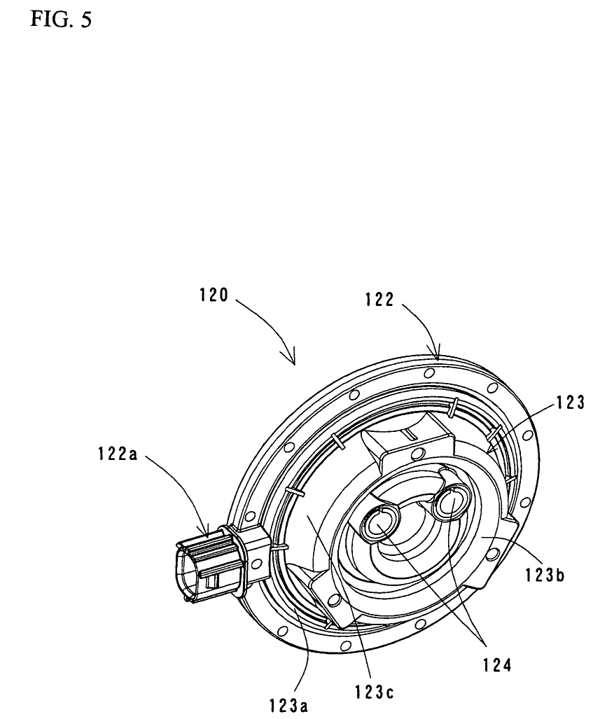

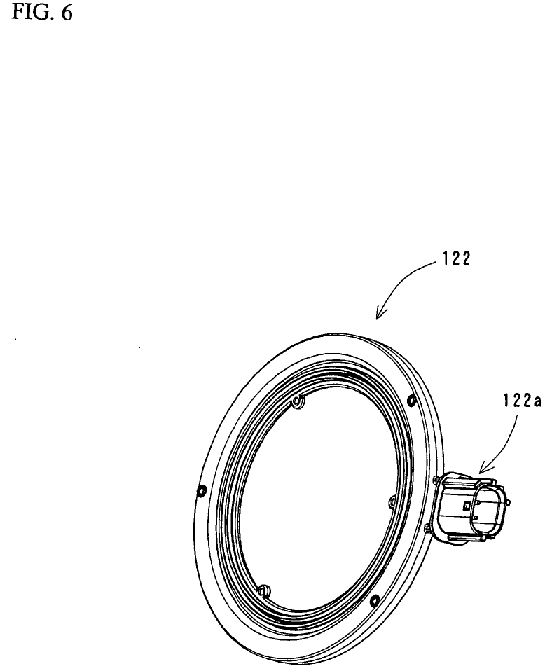

Further detailed structure of the aforementioned detection sensor 120 is described with reference to FIG. 5 through FIG. 8. FIG. 5 is a perspective view of the detection sensor 120 according to an exemplary embodiment and FIG. 6 is a perspective view of the coil housing 122 as a component of the detection sensor 120 shown in FIG. 5.

As shown in FIG. 5 and FIG. 6, the detection sensor 120 includes the coil housing 122, which may be made of resin, and a sensor bracket 123, which is separate from the coil housing 122 and may be made of resin. The coil housing 122 and the sensor bracket 123 are integrally combined by attaching the sensor bracket 123 to the coil housing 122. The detection sensor 120 generally has a two-piece structure including the coil housing 122 and the sensor bracket 123. The sensor bracket 123 is a bracket member between the coil housing 122 and the mounting portion and may be a component of the detection sensor 120, the coil housing 122, or a component of another member than the detection sensor 120 for attaching the detection sensor 120 to the mounting portion.

The coil housing 122 has a generally circular shape and is coaxial with the coil 121. The coil housing 122 and a connecter 122a, to which a harness connector of the vehicle may be connected, are located at a peripheral edge of the sensor 120. The harness connector of the vehicle is connected to the connector 122a and information detected by the coil 121 is transmitted to the deriving unit 150 through the harness connector and a harness of the vehicle.

The sensor bracket 123 is a bottom member or a bottom cylindrical member including a ring-like peripheral portion 123a extending along the ring-like portion of the coil housing 122, a bottom portion 123b having an extending surface parallel to the extending surface of the coil housing 122, and a standing portion 123c between the peripheral portion 123a and the bottom portion 123b. At the peripheral portion 123a, the sensor bracket 123 is combined with the coil housing 122.

The sensor bracket 123 homogeneously holds the ring-like portion of the coil housing 122 via the peripheral portion 123a of the sensor bracket 123 and maintains the rigidity and strength of the coil housing 122 in the held state to maintain the true high detection accuracy of the coil sensor. By maintaining the rigidity and strength of the ring-like coil housing 122 using the sensor bracket 123, the impact mode of a side impact on the vehicle 10 may be detected.

The bottom portion 123b of the sensor bracket 123 defines a pair of bolt holes 124. The bolt holes 124 are used for attaching the coil housing 122, i.e. the detection sensor 120, to a metallic beam bracket 140 welded to the door beam 110 via the sensor bracket 123.

The coil housing 122 may be joined with the sensor bracket 123 using spin welding, a welding method of melting and connecting resin parts by rotating one of the resin parts relative to the other resin part while stressing them so as to generate frictional heat between the resin parts. The relative position of the joined coil housing 122 and sensor bracket 123 in the rotating direction is preferably set according to a positional relationship between the connecter 122a and the bolt holes 124 and while taking the location condition of the detection sensor 120 into consideration. The coil housing 122 is configured such that the sensor bracket 123 may be attached to either side of the coil housing 122, whereby it is possible to select the surface to which the sensor bracket 123 is attached.

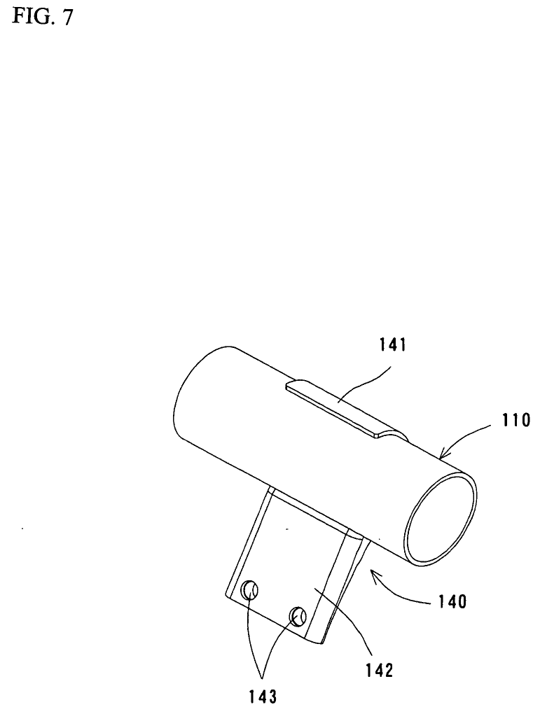

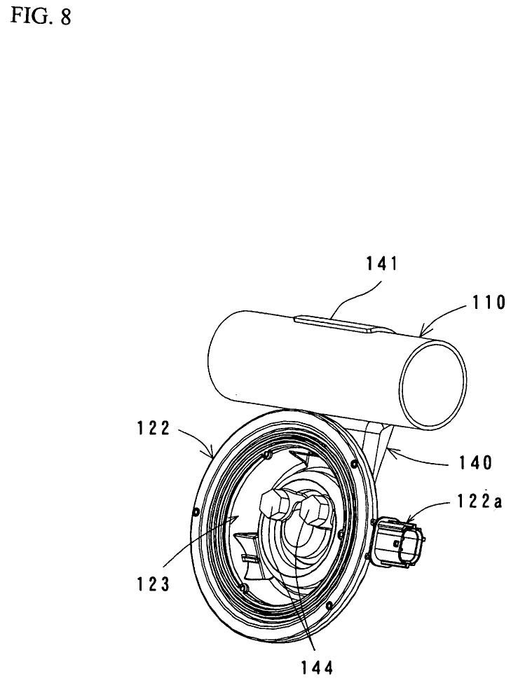

Mounting of the detection sensor 120 is described with reference to FIG. 7 and FIG. 8. FIG. 7 is a perspective view showing a mounting state for the detection sensor 120 according to an exemplary embodiment and FIG. 8 is a perspective view showing the beam bracket 140 to which the detection sensor 120 is attached.

As shown in FIG. 7, the beam bracket 140 is a plate member of which one end portion 141 is welded to the door beam 110 and the other end portion 142 forms an attaching portion for the detection sensor 120. The other end portion 142 of the beam bracket 140 is provided with a pair of bolt holes 143 that are formed to have a space between them that is equal to the space between the pair of bolt holes 124 of the sensor bracket 123. When the bolt holes 143 of the beam bracket 140 and the bolt holes 124 of the sensor bracket 123 are aligned, fixing bolts (fixing bolts 144, 144 shown in FIG. 8) inserted into these bolt holes are screwed in to fix the detection sensor 120 to the beam brackets 140.

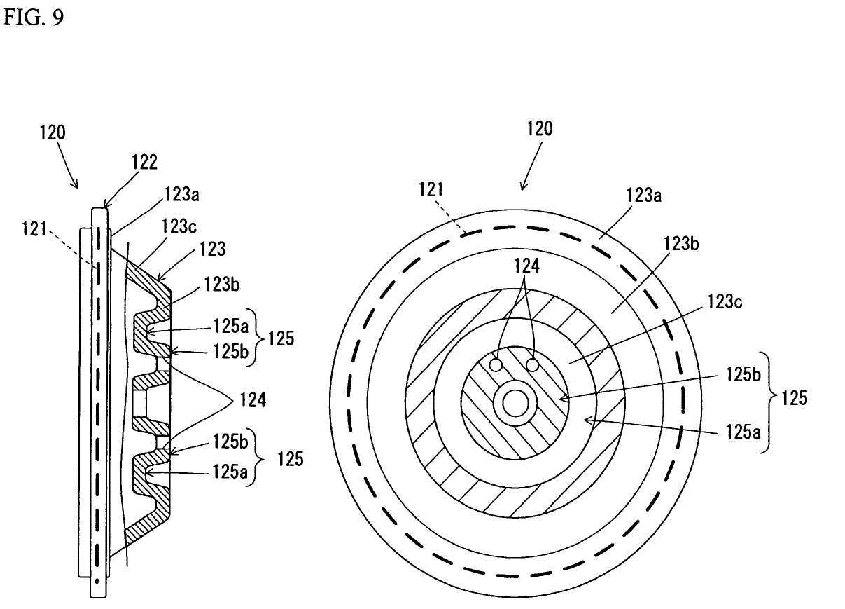

The detailed structure of the sensor bracket 123 of the aforementioned detection sensor 120 shown in FIG. 5 is described with reference to FIG. 9. FIG. 9 schematically illustrates a partial cross section structure and a planar structure of the detection sensor 120 shown in FIG. 5.

As shown in FIG. 9, according to an exemplary embodiment, the sensor bracket 123 includes a reinforcing rib 125 that projects from the extending surface of the bottom portion 123b in a direction perpendicular to the extending surface of the coil housing 122 to reinforce the sensor bracket 123. The reinforcing rib 125 includes coaxial circular portions 125a, 125b that are formed coaxially with the peripheral portion 123a of the sensor bracket 123. One of the coaxial circular portions 125a is a reinforcing portion projecting in a direction toward the peripheral portion 123a and the other coaxial circular portion 125b is a reinforcing portion projecting in a direction opposite to the direction toward the peripheral portion 123a. The pair of bolt holes 124 are formed in the coaxial circular portion 125b. The coaxial circular portions 125a, 125b are each formed in a circle that is continuous in the circumferential direction. The reinforcing rib 125 has a uniform thickness and the coaxial circular portions 125a, 125b form at least one ridge and valley (or a wave) as viewed from a cross section of the reinforcing rib 125 taken along a direction perpendicular to the extending surface of the coil housing.

The sensor bracket 123 may be strongly reinforced by the reinforcing rib 125 to maintain the rigidity and strength of the coil housing 122 at high level. The forming process of the sensor bracket 123 may be easier or more efficient because the reinforcing rib 125 has a constant or uniform thickness. The reinforcing rib 125 may both reinforce the sensor bracket 123 and also mount the sensor bracket 123 to the beam bracket 140 because the pair of bolt holes 124 are formed in the coaxial circular portion 125b of the reinforcing rib 125.

According to other exemplary embodiments, one of the coaxial circular portions 125a, 125b of the reinforcing rib 125 may be omitted or a concavity of the coaxial circular portions 125a, 125b may be solid so the reinforcing rib 125 has a larger thickness at the coaxial circular portions 125a, 125b than that at the other portions. The circle formed by the coaxial circular portions 125a, 125b may be a circle that is intermittent in the circumferential direction.

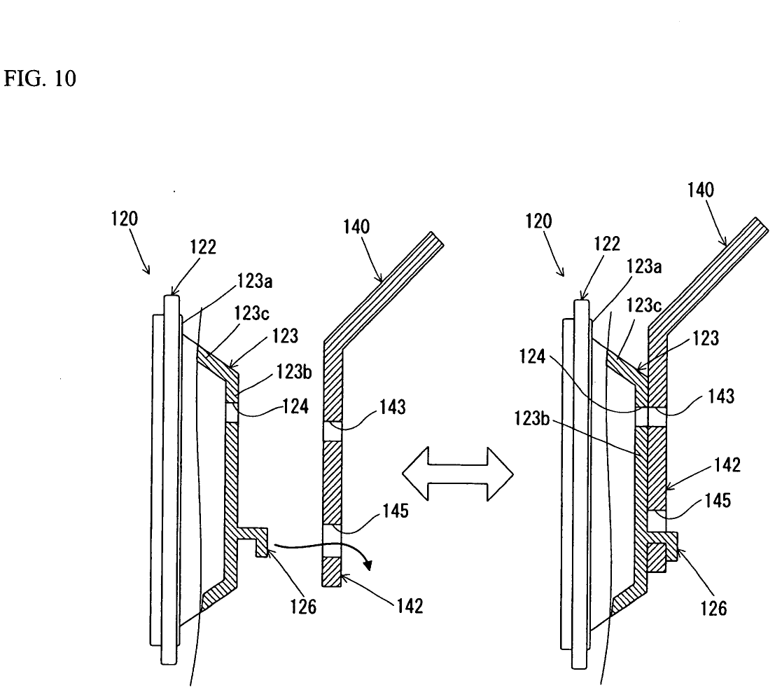

Preferably, a positioning mechanism and method is used for attaching the detection sensor 120 to the beam bracket 140. The positioning function is capable of aligning the bolt holes 124 of the sensor bracket 123 and the bolt holes 143 of the beam bracket 140 and is described with reference to FIG. 10 through FIG. 12.

FIG. 10 schematically shows a first positioning mechanism according to an exemplary embodiment. The sensor bracket 123 includes a hook portion 126 formed on the bottom portion 123b of the sensor bracket 123. The hook portion 126 projects from the bottom portion 123b of the sensor bracket 123 in a direction apart from the coil housing 122 and is capable of catching an opening 145 formed in the other end portion 142 of the beam bracket 140. The bolt holes 124 of the sensor bracket 123 and the bolt holes 143 of the beam bracket 140 are aligned by catching the opening of the beam bracket 140 with the hook portion 126 of the sensor bracket 123.

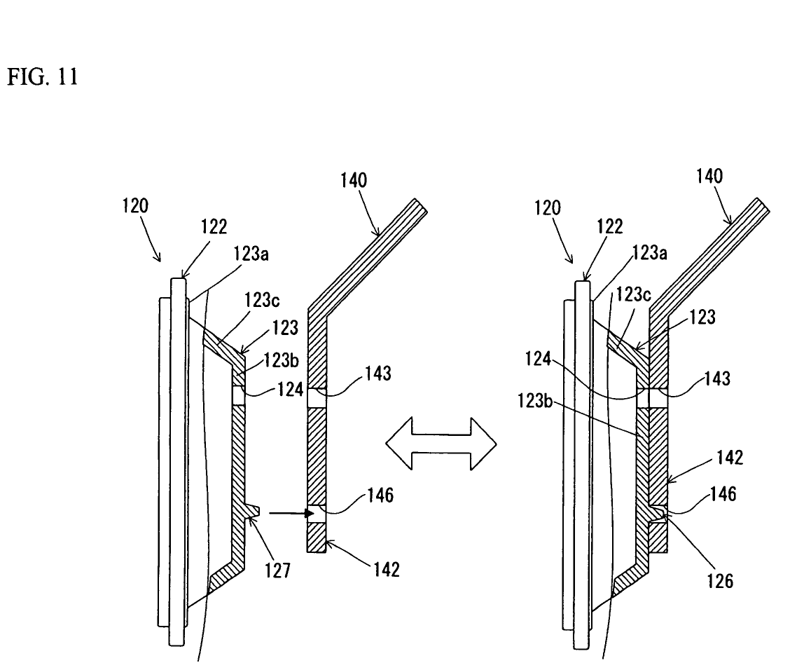

FIG. 11 schematically illustrates a second positioning mechanism according to an exemplary embodiment. The sensor bracket 123 includes a guide pin 127 formed on the bottom portion 123b of the sensor bracket 123. The guide pin 127 projects from the bottom portion 123b of the sensor bracket 123 in a direction away from the coil housing 122 and is capable of fitting in a guide hole or pilot hole (a groove or an opening) that is formed in the other end portion 142 of the beam bracket 140. The bolt holes 124 of the sensor bracket 123 and the bolt holes 143 of the beam bracket 140 may be aligned by fitting the guide pin 127 of the sensor bracket 123 into the guide hole 146 of the beam bracket 140.

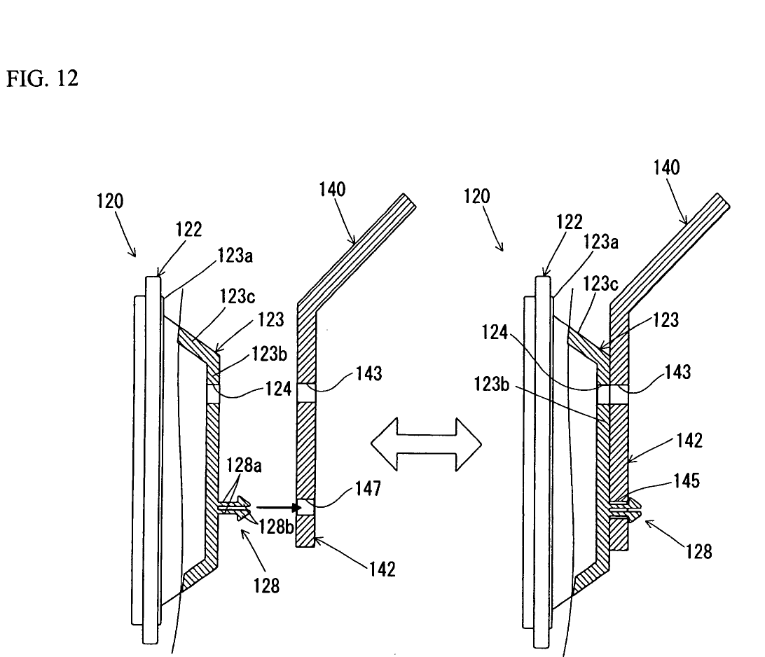

FIG. 12 schematically illustrates a third positioning mechanism according to an exemplary embodiment. The sensor bracket 123 includes a fitting pin 128 formed on the bottom portion 123b of the sensor bracket 123. The fitting pin 128 includes a pair of shaft parts 128a that project from the bottom portion 123b of the sensor bracket 123 in a direction apart from the coil housing 122 and face each other via a slit. The fitting pin also includes a pair of wide parts 128b that are formed at ends of the shaft parts 128a and of which the diameter is larger than that of the shaft parts 128a. The shaft parts 128a may bow about bottoms 123b to deflect the wide parts 128b. The fitting pin 128 of the sensor bracket 123 is inserted into or engaged with a fitting hole 147 of the beam bracket 140 while deflecting the pair of wide parts 128b in a direction closer to each other. Accordingly, the bolt holes 124, 124 of the sensor bracket 123 and the bolt holes 143, 143 of the beam bracket 140 are aligned.

Alignment between the bolt holes 124 of the sensor bracket 123 and the bolt holes 143 of the beam bracket 140 may be achieved without visual confirmation by a worker or without the worker holding the detection sensor 120 by using any one of the first through third positioning mechanisms, thereby improving workability and reducing assembly cost.

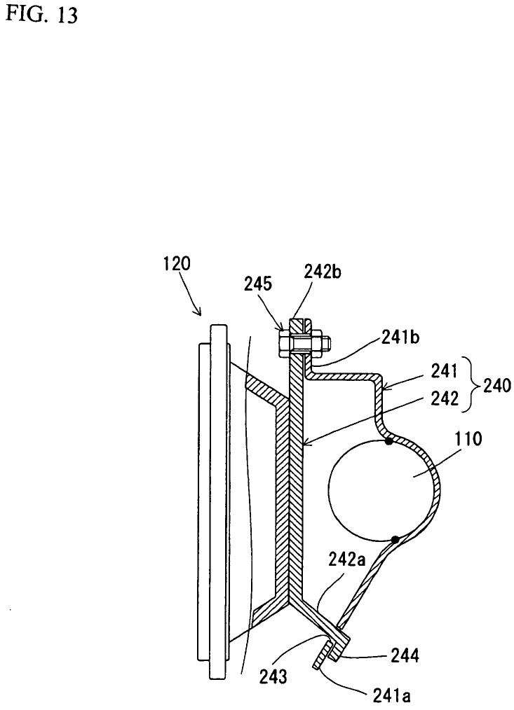

According to other exemplary embodiments, the fixing structure for mounting the detection sensor 120 to the door beam 110 shown in FIG. 5 may be any fixing structure. Alternative fixing structures are described with reference to FIG. 13 through FIG. 17 according to various exemplary embodiments.

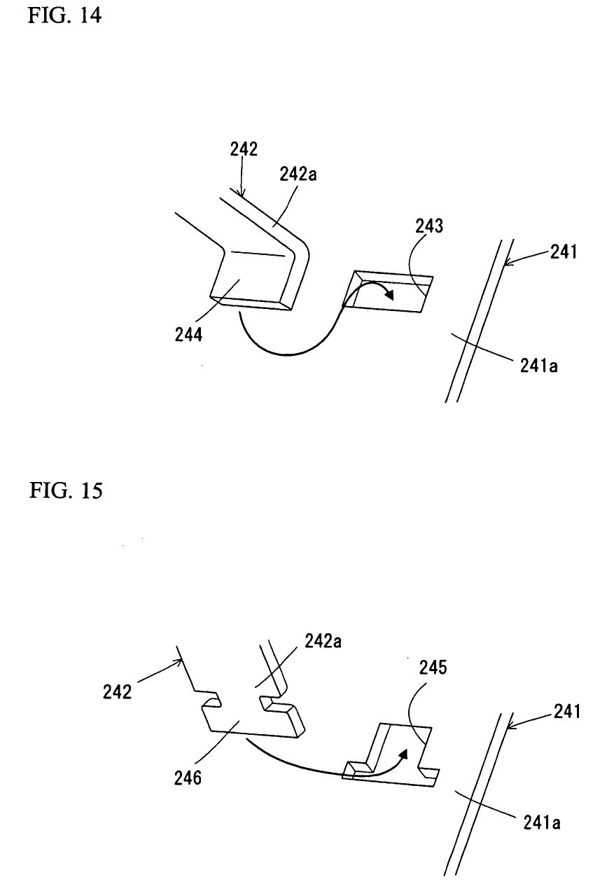

The fixing structure shown in FIG. 13 uses a beam bracket 240 instead of the beam bracket 140 shown in FIG. 5. The beam bracket 240 includes a first bracket piece 241 and a second bracket piece 242. The first bracket piece 241 is welded to the door beam 110 while the second bracket piece 242 is attached to the detection sensor 120 by bolts. The detection sensor 120 is mounted on and fixed to the door beam 110 by fastening the first bracket piece 241 welded to the door beam 110 and the second bracket piece 242 attached to the detection sensor 120 to each other. Specifically, as shown in FIG. 13 and FIG. 14, a hook portion 244 formed on one end portion 242a of the bracket piece 242 is inserted into and slid relative to an opening 243 formed in one end portion 241 a to catch the opening 243 and position the end portions of the first bracket piece 241 and the second bracket piece 242. In addition, the other end portion 241b of the first bracket piece 241 and the other end portion 242b of the second bracket piece 242 are connected tightly by fixing bolts 245.

The structure shown in FIG. 15, may be used instead of the structure shown in FIG. 14 for positioning the one end portion 241a of the first bracket piece 241 and the one end portion 242a of the second bracket piece 242. An engaging portion 246 formed at one end portion 242a is inserted into and slid relative to an opening 245 formed in one end portion 241a of the first bracket piece 241 to catch the opening 245 and position the end portions of the first bracket piece 241 and the second bracket piece 242.

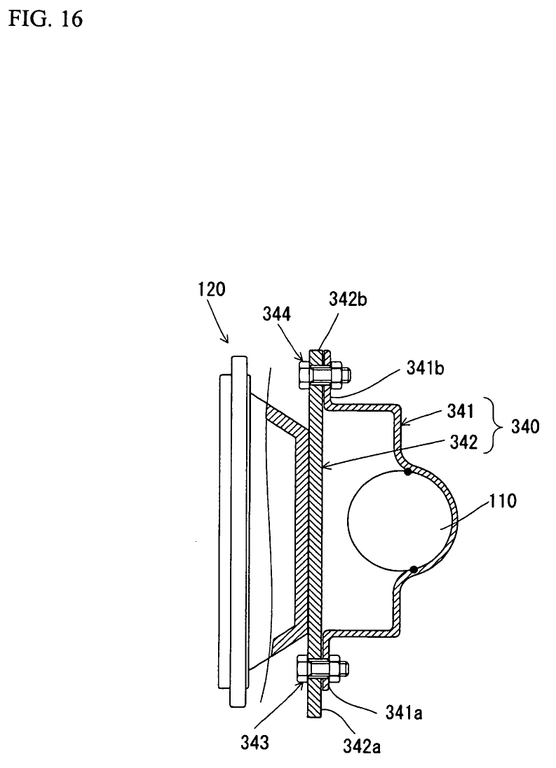

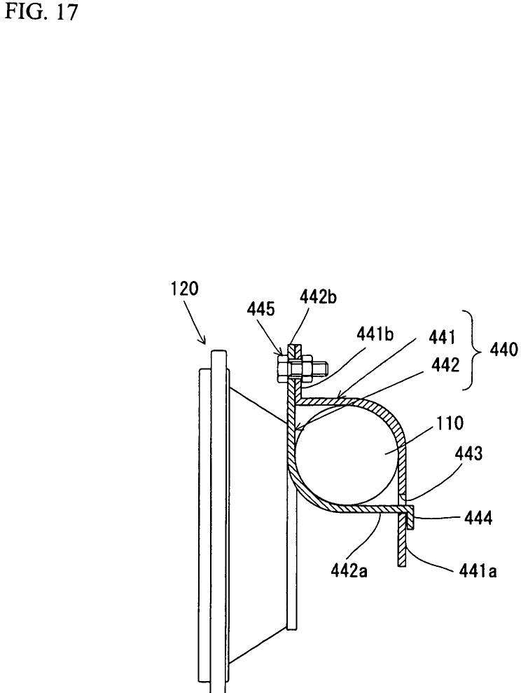

A fixing structure shown in FIG. 16 may use a beam bracket 340 instead of the beam bracket 140 shown in FIG. 5. The beam bracket 340 includes a first bracket piece 341 and a second bracket piece 342. The first bracket piece 341 is welded to the door beam 110 while the second bracket piece 342 is attached to the detection sensor 120 by bolts or the like. By assembling the first bracket piece 341 and the second bracket piece 342 to each other, the detection sensor 120 may be mounted on and fixed to the door beam 110. Specifically, one end portion 341a of the first bracket piece 341 and one end portion 342a of the second bracket piece 342 are connected to each other by a fixing bolt 343. The other end portion 341b of the first bracket piece 341 and the other end portion 342b of the second bracket piece 342 are connected to each other by a fixing bolt 344.

A fixing structure shown in FIG. 17 may use a beam bracket 440 instead of the beam bracket 140 shown in FIG. 5. The beam bracket 440 includes a first bracket piece 441 and a second bracket piece 442. The door beam 110 is sandwiched from its exterior by the first bracket piece 441 and the second bracket piece 442 to which the detection sensor 120 is attached by bolts or the like to mount and fix the detection sensor 120 to the door beam 110. Specifically, and similar to FIG. 14, a hook portion 444 formed on one end portion 442a of the second bracket piece 442 is inserted into and slid relative to an opening 443 formed in one end portion 441a of the first bracket piece 441 to catch the opening 443 and position the end portions of the first bracket piece 441 and the second bracket piece 442. In addition, the other end portion 441b of the first bracket piece 441 and the other end portion 442b of the second bracket piece 442 are generally connected tightly by fixing bolts 445. A structure, for example as shown in FIG. 15, may be use instead of the structure shown in FIG. 14 for positioning the one end portion 441a of the first bracket piece 441 and the one end portion 442a of the second bracket piece 442.

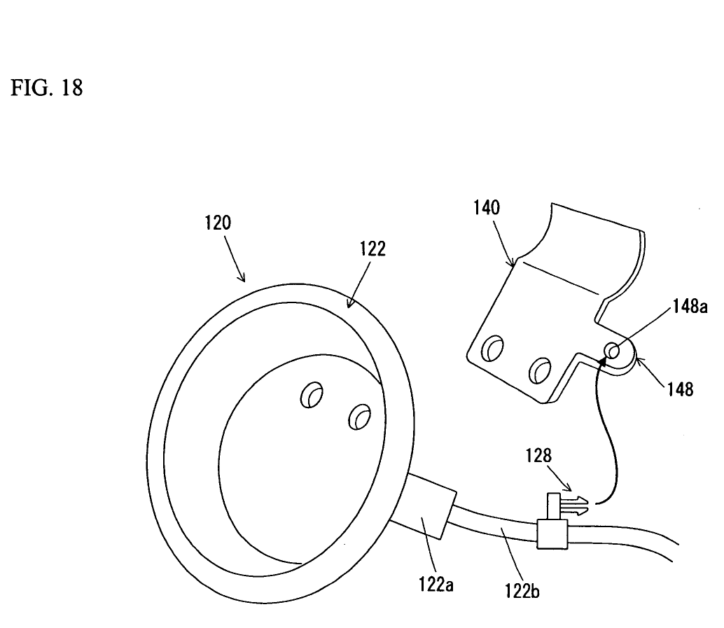

According to some exemplary embodiments, it is preferable in the arrangement shown in FIG. 8 that the beam bracket 140 or the sensor bracket 123 includes a harness holding mechanism for holding the vehicle-side harness extending from the connector 122a of the coil housing 122. Such a harness holding mechanism is described with reference to FIG. 18 through FIG. 21.

FIG. 18 schematically illustrates a first harness holding mechanism according to an exemplary embodiment. The beam bracket 140 includes a projection 148 having a fitting hole 148a formed therein. A vehicle-side harness 122b extending from the connector 122a of the coil housing 122 includes the fitting pin 128. The fitting pin 128 of the vehicle-side harness 122b is inserted into or engaged with the fitting hole 148a of the projection 148 while deflecting the pair of wide parts 128b in a direction closer to each other. Accordingly, the vehicle-side harness 122b may be securely held or fastened by the beam bracket 140.

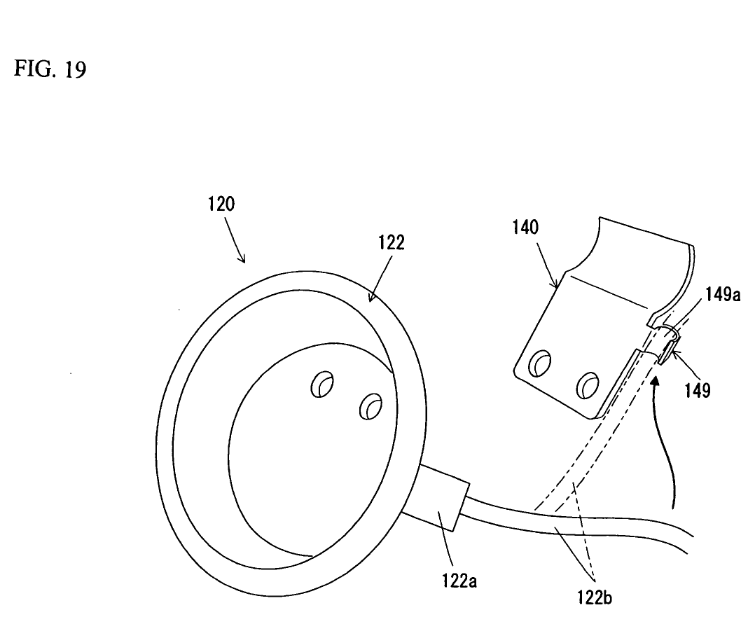

FIG. 19 schematically illustrates a second harness holding mechanism according to an exemplary embodiment. The beam bracket 140 includes a generally half-cylinder projecting piece 149 having a holding space 149a. The vehicle-side harness 122b is directly inserted to the holding space 149a of the projecting piece 149. Accordingly, the vehicle-side harness 122b may be securely held or fastened by the beam bracket 140.

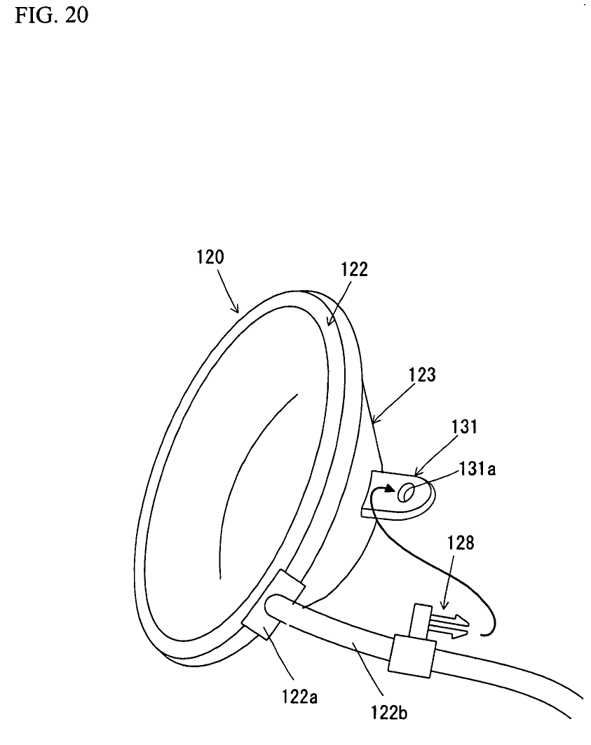

FIG. 20 schematically illustrates a third harness holding mechanism according to an exemplary embodiment. The sensor bracket 123 includes a projection 131 having a fitting hole 131a formed therein. The vehicle-side harness 122b extending from the connector 122a of the coil housing 122 is provided with the fitting pin 128. The fitting pin 128 of the vehicle-side harness 122b is inserted into or engaged with the fitting hole 131a of the projection 131 while deflecting the pair of wide parts 128b in a direction closer to each other. Accordingly, the vehicle-side harness 122b may be securely held or fastened by the sensor bracket 123.

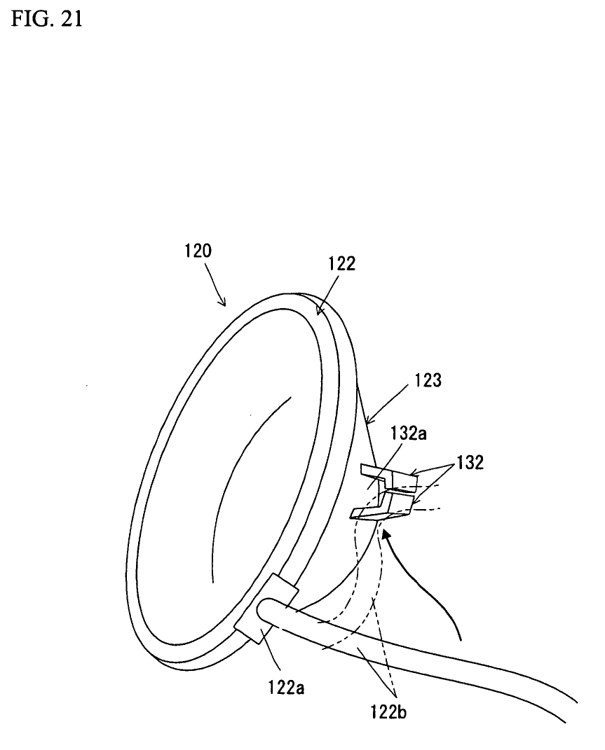

FIG. 21 schematically illustrates a fourth harness holding mechanism according to an exemplary embodiment. The sensor bracket 123 includes a pair of projecting pieces 132 forming a holding space 132a. The vehicle-side harness 122b is directly inserted into the holding space 132a formed by the pair of projecting pieces 132. Accordingly, the vehicle-side harness 122b may be securely held or fastened by the sensor bracket 123.

The vehicle-side harness 122b may be securely held or fastened by the beam bracket 140 or the sensor bracket 123 to preventing the vehicle-side harness 122b from loosening without using a separate harness holding member by using any one of the first through fourth harness holding mechanisms described above.

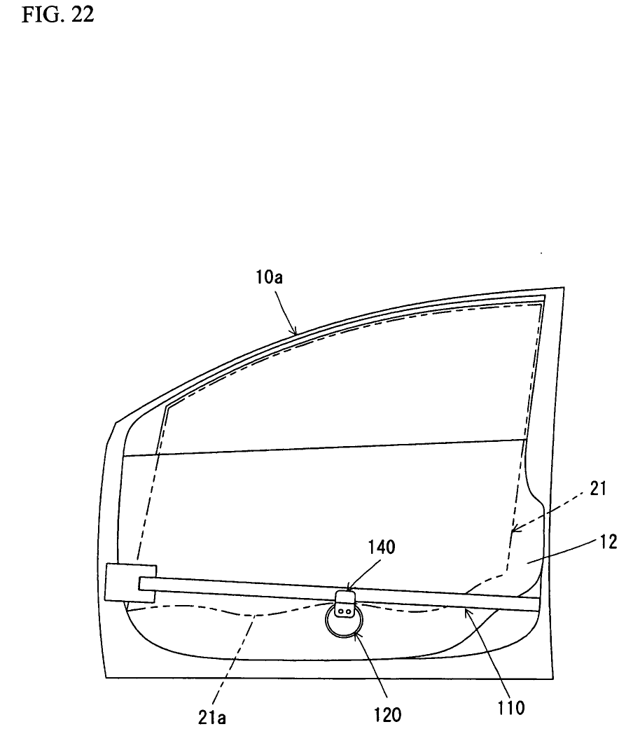

The detection sensor 120 is preferably disposed at a position to avoid or prevent an obstacle from disturbing the detection of the detection object by the detection sensor 120. The obstacle may be physical obstacles (e.g., a door window) that may physically interfere with the detection sensor 120 according to the deformation of the vehicle door in the event of a vehicle collision, and electrical obstacles (e.g., a speaker, a harness, an antenna (radio transceiver), a motor, and a solenoid) that may electrically disturb the detection of the detection object by the detection sensor 120. Avoidance of the obstacle may include an arrangement in which the detection sensor 120 is disposed at a position spaced from every physical obstacle that may physically interfere with the detection sensor 120, an arrangement in which the detection sensor 120 is disposed at a position where the detection sensor 120 is not electrically affected by any obstacle, or a position where electrical influence is below a predetermined reference value may be employed. Structures for avoiding obstacles as mentioned above are described below with reference to FIG. 22 through FIG. 25.

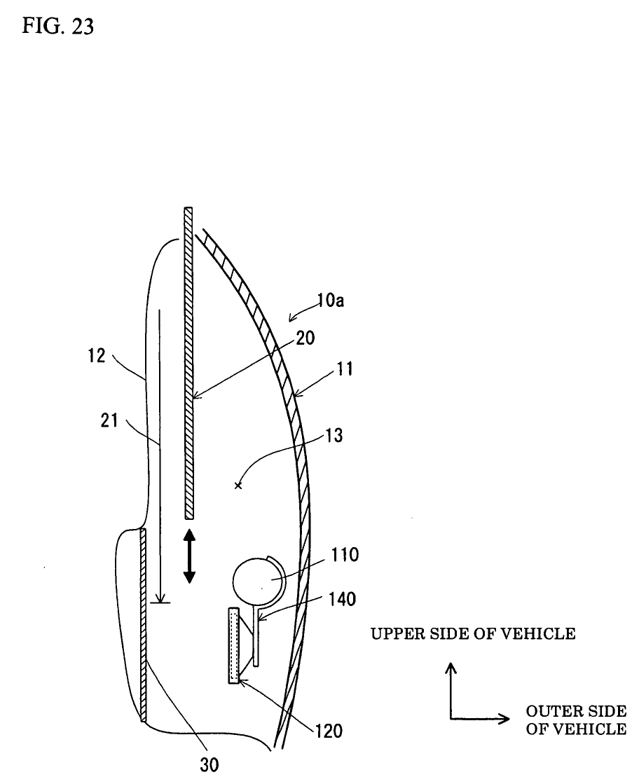

FIG. 22 is an illustration of a first obstacle avoiding structure according to an exemplary embodiment in which the detection sensor 120 is attached to the door beam 110 as seen from the outside of the vehicle with regard to the vehicle door 10a. FIG. 23 is a partial sectional view of FIG. 22. When the detection sensor 120 is attached to the door beam 110 via the beam bracket 140 to detect a confronting surface 130 of the inner door panel 12 (as shown in FIG. 22 and FIG. 23), a window movable range 21 of a glass window 20 is generally formed between the door beam 110 and the inner door panel 12. When the outer door panel 11 of the vehicle door 10a is deformed toward the inner door panel 12 in the event of a vehicle collision, the detection sensor 120 mounted on the door beam 110 may physically interfere with the glass window 120 and disturb the proper action and detection of the detection sensor 120.

The first obstacle avoiding structure shown in FIG. 22 and FIG. 23 uses an arrangement in which the detection sensor 120 is disposed at a position to avoid interference of the window movable range 21 of the glass window 20, which may physically interfere with the detection sensor 120. Typically, it is preferable that the detection sensor 120 is disposed in an area below a lower end 21a in a vertical direction of the window movable range 21 or an area lateral to the window movable range 21 of the glass window 20. According to this arrangement, the detection sensor 120 mounted on the door beam 110 may be physically prevented from interfering with the glass window 20 when the outer door panel 11 of the vehicle door 10a is deformed toward the inner door panel 12 in the event of a vehicle collision to ensure proper action and detection by the detection sensor 120. Because the dead space is easily formed (especially in the area below the lower end 21a of the window movable range 21 within the space 13 in the vehicle door 10a), an arrangement in which the detection sensor 120 is disposed in the illustrated area is flexible and does not require a design change of the vehicle door 10a.

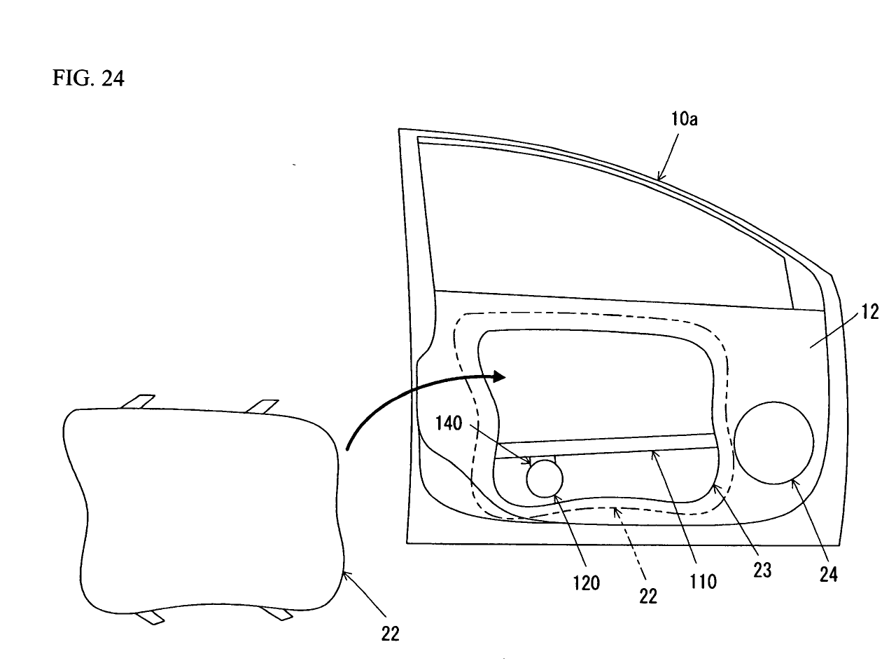

FIG. 24 is an illustration of a second obstacle avoiding structure according to an exemplary embodiment in which the detection sensor 120 is attached to the door beam 110, as viewed from the inside of the vehicle with regard to the vehicle door 10a. The vehicle door 10a shown in FIG. 24 is a vehicle door in which a module panel 22 is detachable relative to a mounting portion of the inner door panel 12. A mounting operation relative to the space 13 defined by the outer door panel 11 and the inner door panel 12 is conducted through an opening 23 that is formed in a central portion of the door when the module panel 22 is removed. The vehicle door 10a has an opening 24 to which a speaker engages or is attached and that is formed on a front side relative to the opening 23 of the vehicle door 10a.

The second obstacle avoiding structure uses an arrangement in which the detection sensor 120 is disposed within a range allowing operation through the opening 23 among locations of the door beam 110. The detection sensor 120 is also disposed at a position where the detection sensor 120 is not electrically affected by the speaker as an electrical obstacle attached to the opening 24 or where electrical influence is below a predetermined reference value. Typically, it is preferable that the detection sensor 120 be disposed on a rear side relative to the center of the vehicle door 10a in the anteroposterior direction of the vehicle. The detection sensor 120 may be prevented from being electrically affected by the speaker or the electrical influence on the detection sensor 120 may be limited to the predetermined reference value to ensure proper action and detection by the detection sensor 120.

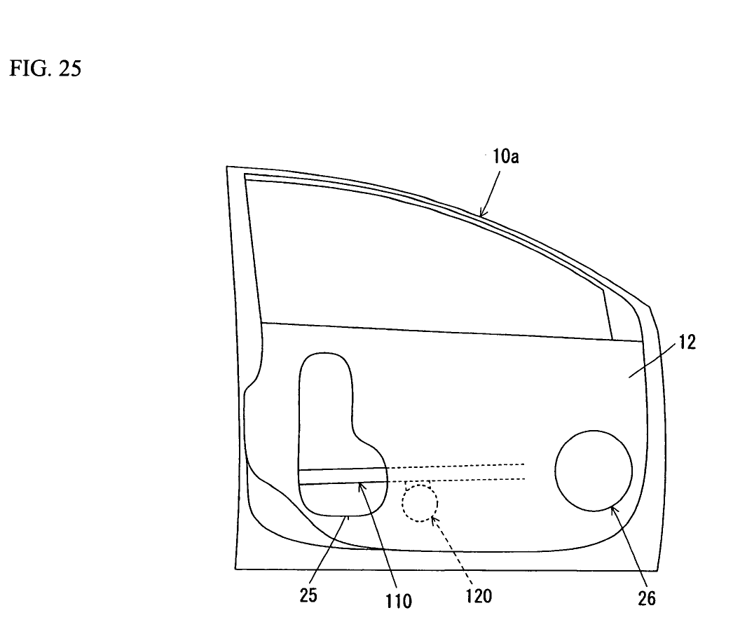

FIG. 25 is an illustration of a third obstacle avoiding structure according to an exemplary embodiment in which the detection sensor 120 is attached to the door beam 110, as viewed from the inside of the vehicle with regard to the vehicle door 10a. The vehicle door 10a shown in FIG. 25 is a vehicle door that is formed in an envelope shape or box shape. A mounting operation relative to the space 13 defined by the outer door panel 11 and the inner door panel 12 is conducted through an opening 25 that is formed on a rear side relative to the center of the vehicle door 10a in the anteroposterior direction of the vehicle. The vehicle door 10a has an opening 26 to which a speaker is engaged or attached and that is formed on a front side relative to the center of the vehicle door 10a in the anteroposterior direction of the vehicle.

The third obstacle avoiding structure uses an arrangement in which the detection sensor 120 is disposed within a range allowing operation through the opening 25 among locations of the door beam 110. The detection sensor 120 is also disposed at a position where the detection sensor 120 is not electrically affected by the speaker as an electrical obstacle attached to the opening 26 or a where electrical influence is below a predetermined reference value. Typically, it is preferable that the detection sensor 120 be disposed on a rear side relative to the center of the vehicle door 10a in the anteroposterior direction of the vehicle. The detection sensor 120 may be prevented from being electrically affected by the speaker or the electrical influence on the detection sensor 120 may be limited to the predetermined reference value to ensure proper action and detection by the detection sensor 120.

The present invention is not limited to the aforementioned exemplary embodiments and various applications and modifications may be made. For example, the following exemplary embodiments are variations of the aforementioned exemplary embodiments.

While the exemplary embodiments have been described with regard to a case where the detection sensor 120 is attached to the door beam 110, the detection sensor 120 may be attached to a member that is not the door beam 110 and that extends between a door front end and a door rear end in the space 13 defined by the outer door panel 11 and the inner door panel 12 of the vehicle door 10a.

Alternatively, the detection sensor 120 may be attached to the inner door panel 12 and the detection sensor 120 may detect the door beam 110 or a metallic body as the detection object. It is preferable that the door beam is a prismatic door beam and a flat surface portion of the door beam is adapted as a confronting surface (detection surface) facing the detection sensor 120.

Although the aforementioned exemplary embodiments have been described where the reinforcing rib 125 is formed in the bottom portion 123b of the sensor bracket 123, the reinforcing rib 125 may be omitted and the bottom portion 123b may be formed in a flat shape. In addition, the first through third positioning mechanisms, the first through fourth harness holding mechanisms, and/or the first through the third obstacle avoiding structures may be omitted according to various exemplary embodiments.

While the aforementioned exemplary embodiments have been described where information detected by the detection sensor 120 is used to control the airbag module 170 to be actuated to restrain a vehicle occupant in the event of a vehicle side impact crash, the information detected by the detection sensor 120 may be used to control an occupant restraint apparatus such as a seat belt device or to control a warning device for outputting graphical/textual or audible warning for informing the vehicle occupant of a vehicle side impact crash.

The priority application, Japanese Patent Application 2008-023192, filed Feb. 1, 2008, including the specification, drawings, claims and abstract, is incorporated herein by reference in its entirety.

Though the aforementioned embodiments has been described with regard to the arrangement of the vehicle occupant restraint system to be installed in an automobile, the present invention may be adopted to occupant restraint systems to be installed in various vehicles such as an automobile, an airplane, a boat, a train, a bus, a truck, and the like.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A side impact detection apparatus for detecting information related to a side impact of a vehicle, comprising:
a detection sensor disposed in a space defined by an outer door panel and an inner door panel of a vehicle door, the detection sensor spaced from a detection object made of a metal; and
a mounting portion to which the detection sensor is attached relative to the vehicle door,
wherein the detection sensor includes a ring-like coil extending parallel to the detection object; a coil housing to accommodate the coil, the coil housing being coaxial with the coil; and a sensor bracket disposed between the coil housing and the mounting portion,
wherein the sensor bracket includes a ring-like peripheral portion joined along a ring-like portion of the coil housing; a bottom portion extending on the opposite side of a detection object with regard to the coil housing, the bottom portion spaced apart from the detection object; and a standing portion between the peripheral portion and the bottom portion; and
wherein the detection sensor detects a distance between the coil and the detection object based on a variation in current flowing through the coil.

2. A side impact detection apparatus as claimed in claim 1, wherein the sensor bracket comprises a rib for reinforcing the sensor bracket, the rib projecting from the bottom portion in a direction perpendicular to the coil housing, the rib comprising one or more coaxial circular portions formed coaxially with the peripheral portion.

3. A side impact detection apparatus as claimed in claim 2, wherein the rib has a predetermined thickness and the one or more coaxial circular portions form at least one valley and ridge as viewed from a section along a direction perpendicular to the extending surface of the coil housing.

4. A side impact detection apparatus as claimed in claim 1, wherein at least one of the coil housing and the sensor bracket comprise a mechanism for holding a harness extending from the coil.

5. A side impact detection apparatus as claimed in claim 1, wherein the detection sensor is located in a position so that obstacles do not disturb detection of the detection object.

6. A side impact detection apparatus as claimed in claim 1, further comprising:
a determination unit for determining the mode of the side impact on the vehicle based on the information detected by the detection sensor.

7. An occupant restraint system comprising:
a side impact detection apparatus comprising a detection sensor disposed in a space defined by an outer door panel and an inner door panel of a vehicle door, the detection sensor spaced from a detection object made of a metal; and a mounting portion to which the detection sensor is attached relative to the vehicle door,
wherein the detection sensor includes a ring-like coil extending parallel to the detection object; a coil housing to accommodate the coil, the coil housing being coaxial with the coil; and a sensor bracket disposed between the coil housing and the mounting portion,
wherein the sensor bracket includes a ring-like peripheral portion joined along a ring-like portion of the coil housing; a bottom portion extending on the opposite side of a detection object with regard to the coil housing, the bottom portion spaced apart from the detection object; and a standing portion between the peripheral portion and the bottom portion; and
wherein the detection sensor detects a distance between the coil and the detection object based on a variation in current flowing through the coil;
a determination unit for determining the mode of the side impact on the vehicle based on the information detected by the detection sensor;
an occupant restraint apparatus for restraining a vehicle occupant in the event of a vehicle side impact crash; and
a control unit for controlling the occupant restraint apparatus based on information from the determination unit of the side impact detection apparatus.

8. A vehicle comprising:
an engine/running system;
an electrical system;
an actuation control device for conducting actuation control of the engine/running system and the electrical system;
a vehicle door for allowing access of a vehicle occupant relative to the vehicle, the vehicle being displaced by a vehicle side impact;
a sensor device for detecting information related to displacement of the vehicle door; and
a control signal output device for outputting a control signal to an object to be controlled based on the information detected by the sensor device,
wherein the sensor device comprises a side impact detection apparatus comprising a detection sensor disposed in a space defined by an outer door panel and an inner door panel of a vehicle door, the detection sensor spaced from a detection object made of a metal; and a mounting portion to which the detection sensor is attached relative to the vehicle door;
wherein the detection sensor includes a ring-like coil extending parallel to the detection object; a coil housing to accommodate the coil, the coil housing being coaxial with the coil; and a sensor bracket disposed between the coil housing and the mounting portion,
wherein the sensor bracket is a bottom member that includes a ring-like peripheral portion joined along a ring-like portion of the coil housing; a bottom portion extending on the opposite side of a detection object with regard to the coil housing, the bottom portion spaced apart from the detection object; and a standing portion between the peripheral portion and the bottom portion; and
wherein the detection sensor detects a distance between the coil and the detection object based on a variation in current flowing through the coil;

9. A system for detecting information related to a side impact of a vehicle, comprising:
a ring like coil conductor disposed in a space defined by an outer door panel and an inner door panel of the vehicle;
wherein the coil is surrounded by a housing and wherein the housing is attached to a bracket located in the vehicle door;
wherein the system is configured to determine the distance between the coil and a metal object based on a variation in current flowing through the coil.

10. The system of claim 9, wherein the bracket is mounted on a vehicle beam located in the vehicle door.

11. The system of claim 9, wherein the bracket includes a ring-like peripheral portion connected to the coil housing.

12. The system of claim 11, wherein the bracket further includes a bottom portion spaced apart from the peripheral portion by a standing portion; wherein the bottom portion is mounted on a vehicle beam located in the vehicle door.

13. The system of claim 12, wherein the bracket includes a ring shaped reinforcing rib located on the bottom portion

14. The system of claim 9, further comprising a control unit for controlling an occupant restraint system based on the current running through the coil.

15. The system of claim 9, wherein the system is configured so that the current through the coil varies based on the distance between the coil and the metal object which is attached to the outer door panel.

16. The system of claim 9, further comprising a determination unit for determining the mode of side impact on the vehicle based on the current through the coil.

17. The system of claim 9, wherein the housing and the coil are coaxially aligned.
